(19) United States
(12) Patent Application Publication
(10) Pub. No.: US 2004/0218347 A1
(43) Pub. Date: Nov. 4, 2004

(54) Flame-retardant electrolyte solution for electrochemical double-layer capacitors

(76) Inventor: Andree Schwake, Heidenheim (DE)

Correspondence Address: FISH & RICHARDSON PC, 225 FRANKLIN ST, BOSTON, MA, 02110, US

(21) Appl. No.: 10/480,910

(22) PCT Filed: May 22, 2002
(86) PCT No.: PCT/DE02/01844

(30) Foreign Application Priority Data
Jun. 13, 2001 (DE) 101 28 581.7

(51) Int. Cl. H01G 9/02

(52) U.S. Cl. 361/504

(57) ABSTRACT

Low-flammability electrolyte solutions with flash points higher than 76° C. are proposed, which contain at least one conducting salt that is dissolved in a solvent mixture of at least one high-polarity component and at least one low-flammability, low-viscosity carbamate component.

Electrochemical capacitors serve as storage devices for power and energy, in which function they are able to emit or absorb high currents and concomitantly high levels of power and energy in relatively short periods of time. For this purpose it is necessary for the capacitors to have low internal electrical resistance. Along with the material of the electrode layers and separator and the cell structure, the internal resistance of an electrochemical capacitor is very substantially dependent on the conductivity of the electrolyte.

According to the current state of the art, electrochemical capacitors with non-aqueous electrolytes preferably use solvent mixtures of at least two or even more components. The mixture must include at least one strongly polar component, which because of its polarity has a strongly dissociative effect on the conducting salts used. Ethylene carbonate and propylene carbonate are generally used as such polar components. The disadvantage of these highly polar solvents is their relatively high viscosity, which severely reduces the mobility of the dissociated conducting salt ions, and hence the conductivity of the electrolyte. To reduce the viscosity of the electrolyte, along with the highly polar solvent one or more low-viscosity solvents are generally used as thinners. Examples of typical thinners are 1,2 dimethoxyethane, 1,3 dioxolane, 2-methyltetrahydrofurane and dimethyl carbonate. The proportion of the thinners is normally between 20 and 60 weight percent of the solvent mixture. The disadvantage of these low-viscosity thinners lies in their very high volatility and the very low flash points of these solvents: 1,2 dimethoxyethane (boiling point 85° C., flash point −6° C.); 1,3 dioxolane (boiling point 78° C., flash point 2° C.); 2-methyltetrahydrofurane (boiling point 80° C., flash point −12° C.); dimethyl carbonate (boiling point 90° C., flash point 18° C.). As a consequence, the solvent mixtures that correspond to the state of the art also have low flash points (e.g. 28.5° C. for the solvent mixture ethylene carbonate:dimethyl carbonate 2:1). Since warming always occurs during the use of electrochemical capacitors, especially at the high currents mentioned earlier, under the present state of the art when faults occur (overloading, short circuit), this represents a significant risk of ignition with the attendant serious consequences, especially when the capacitor housing bursts and electrolyte escapes.

Another disadvantage of the low-viscosity thinners consists in their comparatively low dielectric constants (DKs) and associated low conductivities. For the named thinners these lie between 3 and 7.

There are no equivalent substitutes in electrolytes for electrochemical capacitors at present for the thinners named above. According to the present state of the art, reduced flammability of the electrolyte solution is achieved primarily by increasing the viscosity of the electrolyte solution with binders or fillers, or by using polymeric electrolytes that are practically solid at room temperature. Common to all of these gelatinous solid electrolytes is the fact that because of their high viscosity the mobility of the ions of the salts dissolved in them is much lower than in liquid electrolyte solutions, so that in some cases the necessary conductivities for electrochemical capacitors of high power density can no longer be achieved.

Patent specifications DE 197 24 709 and EP 0 575 191 describe fluorine-substituted and alkyl-substituted carbamates with high flash points and low viscosity as thinner components for low-flammability electrolyte solutions in lithium batteries. They can be used in combination with conventional high-viscosity and polar solvents such as ethylene or propylene carbonate. However, the conductivities of these electrolyte solutions, with values of 2.8 to 6.7 mS/cm at room temperature, are much too low to be considered for use in double-layer capacitors. For double-layer capacitors of high power density, electrolytes with a conductivity of more than 20 mS/cm are required. In electrochemical capacitors, activated carbon electrodes with very large surfaces are sometimes used, which are significantly harder to wet with an electrolyte than the metal oxide electrodes of the lithium batteries. For this reason it is advantageous to optimize electrolyte solutions for use in electrochemical capacitors in such a way that good wetting of the electrodes is ensured. Furthermore, the lithium conducting salts used in lithium batteries are unsuitable for electrolytic capacitors, since metallic lithium can become deposited in the activated carbon electrodes of the capacitor and thereby impair its function.

The object of the present invention is to specify a low-flammability electrolyte solution that avoids the named disadvantages of known electrolyte solutions.

This problem is solved according to the present invention by an electrolyte solution as recited in claim 1. Preferred embodiments of the invention, as well as electrochemical capacitors in which the electrolyte solution according to the present invention may be utilized, are the subject of additional claims.

An electrolyte solution according to the present invention has flash points higher than 76° C. at 1 bar of pressure and conductivities>20 mS/cm at 25° C., and contains the three components A, B and C.

Component A contains at least one solvent with high polarity. Because of its polarity it has a strong dissociative effect on the conducting salt. Solvents with high polarity in accordance with the invention have a dielectric constant (DK)>20. The dielectric constant of a solvent is determinable in a dielectrometer, using methods that are known to persons skilled in the art. They are presented for example in the Römpp Chemielexikon (9th edition) under the term “Dielektrizitäskonstante” (dielectric constant) (pp. 955-956), the entire content of which is hereby referenced.

In contrast to conventional electrolyte solutions, according to the present invention a low-viscosity thinner (component B) with a high flash point is used, so that a low-flammability electrolyte solution results. Low-viscosity solvents in the meaning of the present invention are understood as ones that have a viscosity<2 cP at 25° C. The viscosity of a solvent is determinable for example by using an Ubbelohde viscosimeter.

Alkyl-substituted or fluorine-substituted carbamates are used for the solution component B. The carbamates are characterized by the general formula 1,

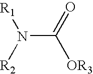

where

R1 and R2, independently of each other, are the same or different and represent a linear C1-C6-alkyl group (R1 and R3=CⱼH₂ⱼ₊₁ where j=1-6), a branched C3-C6-alkyl group (R1 and R3=CₖH₂ₖ₊₁ where k=3-6) or a C3-C7-cycloalkyl group (R1 and R3=CⱼH₂ⱼ₋₁ where j=3-7),

or

according to formula 2

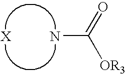

R1 and R2 are combined directly or through one or more additional N and/or O atoms to a ring having 3 to 7 cyclic members, so that X may be described by the total formula CR′R″)ₘOₙ(NR″′)ₒ where 2≦(m+n+o)≦6, where additional N atoms present in the ring are saturated if necessary with C1-C3-alkyl (R″′=CₚH₂ₚ₊₁ where p=0-3) and the ring carbons may also have C1-C3-alkyl groups, while in the remaining R1 and R2 one or more hydrogen atoms may be replaced by fluorine atoms (R′ and R″=CᵣH₍₂ᵣ₊₁₎₋ₛFₛ where r=0-3 and s=0−(2r+1)),

R3 in both formulas is a linear C1-C6-alkyl group (R3=CₜH₂ₜ₊₁ where t=1-6), branched C3-C6-alkyl group (R3=CᵤH₂ᵤ₊₁ where u=3-6), C3-C7-cycloalkyl group (R3=CᵥH₂ᵥ₋₁ where v=3-7) or a partially or perfluorated straight-chain alkyl group with 3 to 7 carbon atoms, one or more of which may be replaced if appropriate with C1-C6-alkyl (R3=C_{w}H_{(2w+1)-x}Fₓ(C_{y}H_{2y+1})_{z} where w=3-7 and x=0−(2w+1) and y=1-6 with z=0−(2w+1) while x+z=(2w+1)).

Component B according to the present invention contains at least one low-flammability carbamate of the general formulas shown above, with low viscosity. Since a number of high-polarity solvents of category A have high viscosity, which prevents the electrolyte solution from attaining a sufficiently high conductivity, component B serves to lower the viscosity of the solvent mixture. The result is a solvent mixture according to the present invention with a flash point higher than 76° C. at 1 bar and a conductivity (>20 mS/cm at 25° C.) comparable to or even greater than conventional capacitors of high power density. The solvent mixture of components A and B with maximum conductivity does not have a maximum polarity, expressed by a large to maximum dielectric constant (DK), but harmonized with each other a non-maximum DK and a non-minimum viscosity, which in combination result in a maximum conductivity. Since component B according to the present invention has a high flash point, solvent solutions with high conductivity are produced that are of low flammability compared to solvent solutions that correspond to the state of the art. Conducting salts that contain no lithium are used according to the present invention as component C. That makes it possible to prevent metallic lithium from being deposited in the activated carbon electrodes and impairing their functioning. In addition, Li-free electrolyte solutions have higher conductivities than electrolyte solutions that contain Li salts.

High-polarity, high-viscosity solvents for component A may be selected from the group of cyclic carbonates, for example ethylene carbonate or propylene carbonate. Component A may also be selected from the following nitriles: acetonitrile, 3-methoxyproprionitrile, glutaronitrile and succinonitrile. Component A may also be lactones, for example γ-butyrolactone and/or γ-valerolactone. It is also possible in the electrolyte solutions according to the present invention to mix the named solvents in any way desired, so that component A may also be for example a mixture of propylene carbonate and acetonitrile.

Preferably it is possible to utilize 2,2,2-trifluoroethyl-N,N-dimethylcarbamate, 2,2,2-trifluoroethyl-N,N-diethylcarbamate, methyl-N,N-dimethylcarbamate, ethyl-N,N-dimethylcarbamate and methyl-N,N-diethylcarbamate. In contrast to conventional low-viscosity thinners they have significantly higher flash points, but while their viscosity remains at nearly the same low level they have higher dielectric constants (for example 12.5 for methyl-N,N-dimethylcarbamate compared to a dielectric constant of 2.1 for dimethyl carbonate). The carbamates used according to the present invention are normally usable in concentration ranges between 10 and 60 weight percent, where solvent mixtures with maximum conductivities and at the same time high flash points above 76° C. at 1 bar preferably contain 30 to 50 weight percent of the aforementioned carbamates.

Possibilities for component C include lithium-free conducting salts based on onium salts with nitrogen or phosphorous as the central atom. For example, one may use quaternary ammonium or phosphonium cations such as tetraethyl ammonium or methyltriethyl ammonium in combination with anions such as tetrafluoroborate, hexafluorophosphate, hexafluoroarsenate, hexafluoroantimonate, borate, for example oxalatoborate, bis(trifluoromethylsulfonyl)imide, trifluoromethyl sulfonate, tris(trifluoromethylsulfonyl)methide or tetrachloroaluminate. Also possible is the use of molten conducting salts with organic cations, for example on the basis of imidazolium or pyrrolidinium cations in combination with the anions named above. In addition, it is also possible to use pyridinium and morpholinium cations, and as anions borates of the general formula B(OR)₄⁻, where R is selected from the following substituents:

C1 to C6 alkyl groups,

—OC—(R1)ₓ where x=0.1, with R1 being a C1 to C6 alkyl group.

It is also possible for two substituents to be linked together via the carbon atoms, so that the two oxygen atoms that contact the boron atom are bridged. For example, if all four substituents R are an —OC—(R1)ₓ group where x=0 and in each case two of the substituents are linked to each other via the carbon atom of the keto group, the result is the oxalatoborate B(OOCCOO)₂⁻ mentioned earlier.

Also possible is the use of mixtures of more than one conducting salt. Good results with sufficiently high conductivities are also achieved with standard conducting salts such as tetraalkylammonium tetrafluoroborates. In contrast to the aforementioned lithium salts, these conducting salts do not become deposited in activated carbon electrodes, and are therefore especially well suited for use in electrochemical capacitors. The conducting salts are advantageously used in the electrolyte solutions according to the present invention at a concentration>0.7 mol/l, preferably at a concentration>1 mol/l.

The viscosity of the electrolyte solution is adjusted when adding the various components so that at the same time good wetting of the carbon electrodes may be ensured.

Since the carbamates have better electrochemical stability than conventional low-viscosity thinners, electrochemical capacitors with electrolyte solutions according to the present invention containing the carbamates named above are operated at higher cell voltages>2.5 V, preferably 2.7 V, most preferably 3 V. Because of the elevated cell voltages, these electrochemical capacitors also have an advantageously increased power and energy density. Because of the low flammability of the electrolyte solutions, capacitors having electrolyte mixtures according to the present invention may be used at higher temperatures than conventional capacitors. Moreover the risk of the capacitor electrolyte igniting when electrolyte escapes from the capacitor housing is lower than for capacitors according to the present state of the art.

The present invention is further elucidated below on the basis of exemplary embodiments. The physical properties of some selected carbamates are indicated in the associated Table 1. The properties named are the dielectric constant, the viscosity and the boiling point, which correlates directly with the flash point (a higher boiling point causes a higher flash point).

TABLE 1

| | | Viscosity | |
|---|---|---|---|
| Carbamate | Dielectric constant | (mPa · s) | Boiling point (° C.) |
| ethyl-N,N-di- | 11.0 | 0.9 | 145-146 |
| ethylcarbamate | 10.3 | 1.2 | 157-158 |
| methyl-N,N-di- | | | |
| ethylcarbamate | | | |
| methyl-N,N- | 12.5 | 0.8 | 131-133 |
| dimethylcar- | | | |
| bamate | | | |

### EXAMPLE 1

### Production of a Low-Flammability Electrolyte Solution on the Basis of methyl-N,N-dimethylcarbamate

Propylene carbonate and methyl-N,N-dimethylcarbamate are mixed in a weight ratio of 1:1 as components A and B. As the conducting salt (component C), 1.4 M tetraethylammonium tetrafluoroborate is added. This electrolyte solution has a conductivity at room temperature of more than 21 mS/cm and a boiling point of more than 131° C.

### EXAMPLE 2

### Production of a Low-Flammability Electrolyte Solution on the Basis of 2,2,2-trifluoroethyl-N,N-dimethylcarbamate

As components A and B, ethylene carbonate and 2,2,2-trifluoroethyl-N,N-dimethylcarbamate are mixed in a weight ratio of 2:1. As the conducting salt, 1 M tetraethylammonium tetrafluoroborate is added. This electrolyte solution has a flash point higher than 85° C.

### EXAMPLE 3

### Production of a Low-Flammability Electrolyte Solution on the Basis of ethyl-N,N-dimethylcarbamate

As components A and B, propylene carbonate and ethyl-N,N-dimethyl caramate are mixed at a weight ratio of 1.5:1. As the conducting salt, 1.4 M methyltriethylammonium tetrafluoroborate is added. This electrolyte solution has a conductivity at room temperature greater than 21 mS/cm and a flash point higher than 90° C.

The electrolyte solutions according to the present invention may be used advantageously in electrochemical double-layer capacitors with low internal resistance, as revealed in U.S. Pat. No. 6,094,788, the entire content of which is hereby referenced.

The electrodes of these double-layer capacitors are preferably made up of a large number of metal-impregnated activated carbon cloths, with each activated carbon cloth having electrically conductive contact with one end of a current collector foil. The purpose of these foils is to lower the internal resistance of the activated carbon electrodes. The other ends of the current collector foils of electrodes having the same polarity are combined into a bundle, so that an electrode terminal to which an electrical potential may be applied is formed both for the anode and for the cathode. The electrodes of opposite polarity are separated and electrically isolated by porous separators saturated with operating electrolyte. The resulting stack of alternating activated carbon cloths and porous separators is packed under light pressure into a housing, so that as large a contact area as possible is produced between the current collector foils and the activated carbon cloth electrodes. It is also possible to use carbon powder electrodes in the configuration described above.

In addition, the electrolyte solutions according to the present invention may be used in hybrid capacitors with metal oxide electrodes or combinations of metal oxide electrodes with electrodes in the form of activated carbon cloths or activated carbon powder. Also possible are pseudocapacitors that contain conductive polymers or combinations of conductive polymers with electrodes in the form of activated carbon cloths or activated carbon powder, or conductive polymers in combination with metal oxide electrodes. Renditions of the electrochemical capacitors may include components of cylindrical or prismatic form. Also possible are radial capacitors in which the electrode connections are located on one side, or axial capacitors in which one connection is on the top and one on the bottom of the component.

Also an object of the present invention is an aluminum electrolyte capacitor with the electrolyte solutions according to the present invention, which may be used at higher operating temperatures because of these electrolyte solutions. Aluminum electrolyte capacitors have electrodes that include aluminum foils. Between the electrodes there are porous separators, so that sequences of layers consisting of electrodes and separators are formed. Both the electrodes and the separator are in contact with the electrolyte solution. The sequences of layers of electrodes and separators are frequently rolled up into capacitor wraps.

As separators in all of the types of capacitor named above one may advantageously use porous polymer films, fleeces, felts or woven fabrics of polymers or fiberglass, or even absorbent papers.

The exemplary embodiments represent only examples. Variations are possible both in terms of the composition of the electrolytes and in regard to the electrochemical capacitors used.

1. A low-flammability electrolyte solution for electrochemical capacitors, with a conductivity>20 mS/cm at 25° C. and a flash point higher than 76° at 1 bar, comprising:
component A containing at least one solvent of high polarity with a DK>20, and
component B containing at least one additional solvent to lower the viscosity, which is selected from carbamates having the general formula 1, 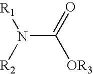
wherein
each of R1 and R2, independently represents a linear C1-C6-alkyl group (R1 and R3=CⱼH₂ⱼ₊₁ where j=1-6), a branched C3-C6-alkyl group (R1 and R3=CₖH₂ₖ₊₁ where k=3-6) or a C3-C7-cycloalkyl group (R1 and R3=CⱼH₂ⱼ₋₁ where j=3-7),
or
according to formula 2 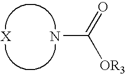
R1 and R2 are combined directly or through one or more additional N and/or O atoms to a ring having 3 to 7 cyclic members, so that X may be described by the total formula (CR′R″)ₘOₙ(NR″′)ₒ where 2≦(m+n+o)≦6, where R″′=CₚH₂ₚ₊₁ where p=0-3, while in the remaining R1 and R2 one or more hydrogen atoms may be replaced by fluorine atoms: R′ and R″=CᵣH₍₂ᵣ₊₁₎₋ₛFₛ where r=0-3 and s=0−(2r+1),
R3 in both formulas is a linear C1-C6-alkyl group (R3=CₜH₂ₜ₊₁ where t=1-6), branched C3-C6-alkyl group (R3=CᵤH₂ᵤ₊₁ where u=3-6), C3-C7-cycloalkyl group (R3=CᵥH₂ᵥ₋₁ where v=3-7) or a partially or perfluorated straight-chain alkyl group with 3 to 7 carbon atoms, one or more of which may be replaced if appropriate with C1-C6-alkyl:
R3=C_{w}H_{(2w+1)-x}Fₓ(C_{y}H_{2y+1})_{z} where w=3-7 and x=0−(2w+1) and y=1-6 with z=0−(2w+1) while x+z=(2w+1), and
component C containing at least one conducting salt that contains no lithium.

2. The electrolyte solution of claim 1,
wherein the carbamate is contained in a proportion of 10 to 60 percent by weight.

3. The electrolyte solution of claim 2,
wherein the carbamate is contained in a proportion of 30 to 50 percent by weight.

4. The electrolyte solution of claim 1,
wherein component A contains one or more cyclic carbonates.

5. The electrolyte solution of claim 4,
wherein component A is ethylene carbonate or propylene carbonate.

6. The electrolyte solution of claim 1,
wherein component A is a nitrile.

7. The electrolyte solution claim 6,
wherein component A is selected from the following nitriles:
acetonitrile,
3-methoxyproprionitrile,
glutaronitrile, and
succinonitrile.

8. The electrolyte solution of claim 1,
wherein component A is alactone.

9. The electrolyte solution of claim 8,
wherein component A is selected from the following lactones:
γ-butyrolactone, and
γ-valerolactone.

10. The electrolyte solution of claim 1,
wherein component A contains propylene carbonate and component B contains methyl-N,N-dimethylcarbamate.

11. The electrolyte solution of claim 10,
wherein the propylene carbonate and methyl-N,N-dimethylcarbamate are contained in approximately equal proportions by weight.

12. The electrolyte solution of claim 1,
wherein component A contains ethylene carbonate and component B contains 2,2,2-trifluoroethyl-N,N-dimethylcarbamate.

13. The electrolyte solution of claim 12,
wherein the solution mixture of components A and B contains ethylene carbonate and 2,2,2-trifluoroethl-N,N-dimethylcarbamate at a ratio of approximately 2:1 by weight.

14. The electrolyte solution of claim 1,
wherein component A contains propylene carbonate and component B contains ethyl-N,N-dimethylcarbamate.

15. The electrolyte solution of claim 14,
wherein propylene carbonate and ethyl-N,N-dimethylcarbamate are at a ratio of approximately 1.5:1 by weight.

16. The electrolyte solution of claim 1,
wherein component C is selected from combinations of quaternary ammonium cation, phosphonium cation, imidazolium cation, pyridinium cation, morpholinium cation, pyrrolidinium cation, or a mixture thereof with tetrafluoroborate anion, hexafluorophosphate anion, hexafluoroarsenate anion, hexafluoroantimonate anion, borate anion, bis(trifluoromethylsulfonyl)imide anion, trifluoromethylsulfonate anion, tris(trifluoromethylsulfonyl)methide anion, tetrachloroaluminate anion, fluoralkylphosphates anion, fluoralkylarsenates anion, fluoralkylantimonates anion, oxalatoborate anion, B(OR)₄⁻ anion, or a mixture thereof, where each R group is:
a C1 to C6 alkyl group, and two R groups may be connected to each other so that two oxygen atoms are bridged, or
a —OC—(R1)ₓ group where x=0, or 1, R1 is a C1 to C6 alkyl group, and two R groups may be connected to each other via carbon atoms so that two oxygen atoms that contact the boron atom are bridged.

17. The electrolyte solution of claim 16,
wherein component C is tetraethylammonium tetrafluoroborate or methyltriethylammonium tetrafluoroborate or a mixture of the two salts.

18. The electrolyte solution of claim 17,
wherein component C is present at a concentration>0.7 mol/l.

19. The electrolyte solution of claim 11
wherein component C is tetraethylammonium tetrafluoroborate at a concentration greater than 0.7 mol/l.

20. The electrolyte solution of claim 15,
wherein methyltriethylammonium tetrafluoroborate is at a concentration greater than 1 mol/l.

21. An electrochemical double-layer capacitor with electrodes consisting of activated carbon cloths or activated carbon powder and porous separators located between them, comprising
a low-flammability electrolyte solution of claim 1.

22. The electrochemical double-layer capacitor of claim 21, wherein
the capacitor consists of alternating layers of electrodes, built up of metal-impregnated activated carbon cloths with current collector foils located between them, where each of the current collector foils has a first end and a second end, the first end of each current collector foil contacting the electrically conductive zones of an activated carbon cloth,
the second end of each current collector foil is combined with the second ends of the other current collector foils of electrodes of the same polarity into a bundle, so that they form an electrode terminal to which an electrical potential may be applied,
electrodes of differing polarity are separated and electrically isolated by porous separators, and
the alternating layers of electrodes are packed under light pressure in a housing, so that a large contact area is produced between the current collector foils and the activated carbon cloths.

23. A hybrid capacitor with metal oxide electrodes or combinations of metal oxide electrodes and electrodes of activated carbon cloths or activated carbon powder and porous separators located between them, comprising a low-flammability electrolyte solution according to claim 1.

24. A pseudocapacitor with electrodes of conductive polymers and/or electrodes of activated carbon cloths or activated carbon powder and porous separators located between them, comprising
a low-flammability electrolyte solution according to claim 1.

25. The electrochemical capacitor of claim 21, wherein the capacitor is formed as a cylindrical, prismatic, radial or axial component.

26. The electrochemical capacitor of claim 21, wherein the capacitor includes polymer films, fleeces, felts, woven fabrics of polymers or fiberglass or papers as separators.

27. An aluminum electrolyte capacitor having electrodes consisting of aluminum foil and separators located between the electrodes, comprising a low-flammability electrolyte solution claim 1.

28. (Canceled)

29. The electrochemical capacitor of claim 22, wherein the capacitor is formed as a cylindrical, prismatic, radial or axial component.

30. The electrochemical capacitor of claim 23, wherein the capacitor is formed as a cylindrical, prismatic, radial or axial component.

31. The electrochemical capacitor of claim 24, wherein the capacitor is formed as a cylindrical, prismatic, radial or axial component.

32. The electrochemical capacitor of claim 22, wherein the capacitor includes polymer films, fleeces, felts, woven fabrics of polymers or fiberglass or papers as separators.

33. The electrochemical capacitor of claim 23, wherein the capacitor includes polymer films, fleeces, felts, woven fabrics of polymers or fiberglass or papers as separators.

34. The electrochemical capacitor of claim 24, wherein the capacitor includes polymer films, fleeces, felts, woven fabrics of polymers or fiberglass or papers as separators.

35. The electrochemical capacitor of claim 25, wherein the capacitor includes polymer films, fleeces, felts, woven fabrics of polymers or fiberglass or papers as separators.

36. The electrochemical capacitor of claim 29, wherein the capacitor includes polymer films, fleeces, felts, woven fabrics of polymers or fiberglass or papers as separators.

37. The electrochemical capacitor of claim 30, wherein the capacitor includes polymer films, fleeces, felts, woven fabrics of polymers or fiberglass or papers as separators.

38. The electrochemical capacitor of claim 31, wherein the capacitor includes polymer films, fleeces, felts, woven fabrics of polymers or fiberglass or papers as separators.

39. The electrolyte solution of claim 13,
wherein component C is tetraethylammonium tetrafluoroborate at a concentration greater than 0.7 mol/l.
